(19) United States
(12) Patent Application Publication
(10) Pub. No.: US 2016/0179793 A1
(43) Pub. Date: Jun. 23, 2016

(54) CRAWLING COMPUTER-BASED OBJECTS

(71) Applicant: International Business Machines Corporation, Armonk, NY (US)

(72) Inventors: Shahar Sperling, Tel Mond (IL); Omer Tripp, Bronx, NY (US)

(21) Appl. No.: 15/068,799

(22) Filed: Mar. 14, 2016

Related U.S. Application Data
(63) Continuation of application No. 14/040,861, filed on Sep. 30, 2013.

(51) Int. Cl. G06F 17/30

(52) U.S. Cl. CPC G06F 17/30

(57) ABSTRACT

Crawling computer-based objects by identifying a dependency between a first portion of a computer-based object set and a second portion of the computer-based object set, where the second portion is data-dependent on the first portion, and responsive to identifying the dependency, effecting a crawling of the first portion and thereafter a crawling of the second portion.

### DOMESTIC PRIORITY

This application is a continuation of the legally related U.S. application Ser. No. 14/040,861 filed Sep. 30, 2013, which is fully incorporated herein by reference.

### FIELD OF THE INVENTION

The invention relates to crawling computer-based objects in general, and more particularly to crawling Rich Internet Applications.

### BACKGROUND

“Crawling” in modern computer parlance commonly refers to traversing and cataloguing computer-based objects, such as Hypertext Markup Language (HTML)-encoded web pages or other types of computer software application interfaces. Typically, a “crawler” discovers the links within an object that refer to other linked objects, navigates to the linked objects via the links, discovers the links within those objects, and so on.

Crawling so-called Rich Internet Applications (RIAs) that include client-side scripting and dynamic content presents certain challenges. For example, consider a web page of an RIA that includes a disabled link to a destination web page, where the link is only enabled if the user has entered data into a particular field, such as a customer ID, and where the link causes the field's data to be provided to the destination web page. A crawler that extracts the link from the web page and navigates to the destination web page will likely encounter an error message. Alternatively, were the web page configured without the destination web page link at all, but with a script that performs an AJAX call that validates the customer ID and only then returns the link to the web page, the crawler would likely not see the link at all.

### SUMMARY

In one aspect of the invention a method is provided for crawling computer-based objects, the method including identifying a dependency between a first portion of a computer-based object set and a second portion of the computer-based object set, where the second portion is data-dependent on the first portion, and responsive to identifying the dependency, effecting a crawling of the first portion and thereafter a crawling of the second portion.

In other aspects of the invention systems and computer program products embodying the invention are provided.

### BRIEF DESCRIPTION OF THE SEVERAL VIEWS OF THE DRAWINGS

The invention will be understood and appreciated more fully from the following detailed description taken in conjunction with the appended drawings in which:

FIG. 1 is a simplified conceptual illustration of a system for crawling computer-based objects, constructed and operative in accordance with an embodiment of the invention;

FIG. 2 is a simplified flowchart illustration of an exemplary method of operation of the system of FIG. 1, operative in accordance with an embodiment of the invention;

FIG. 3 is an example illustrating an application of the system of FIG. 1 and method of FIG. 2; and

FIG. 4 is a simplified block diagram illustration of an exemplary hardware implementation of a computing system, constructed and operative in accordance with an embodiment of the invention.

### DETAILED DESCRIPTION

The invention is now described within the context of one or more embodiments, although the description is intended to be illustrative of the invention as a whole, and is not to be construed as limiting the invention to the embodiments shown. It is appreciated that various modifications may occur to those skilled in the art that, while not specifically shown herein, are nevertheless within the true spirit and scope of the invention.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical data storage device, a magnetic data storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java™, Smalltalk™, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

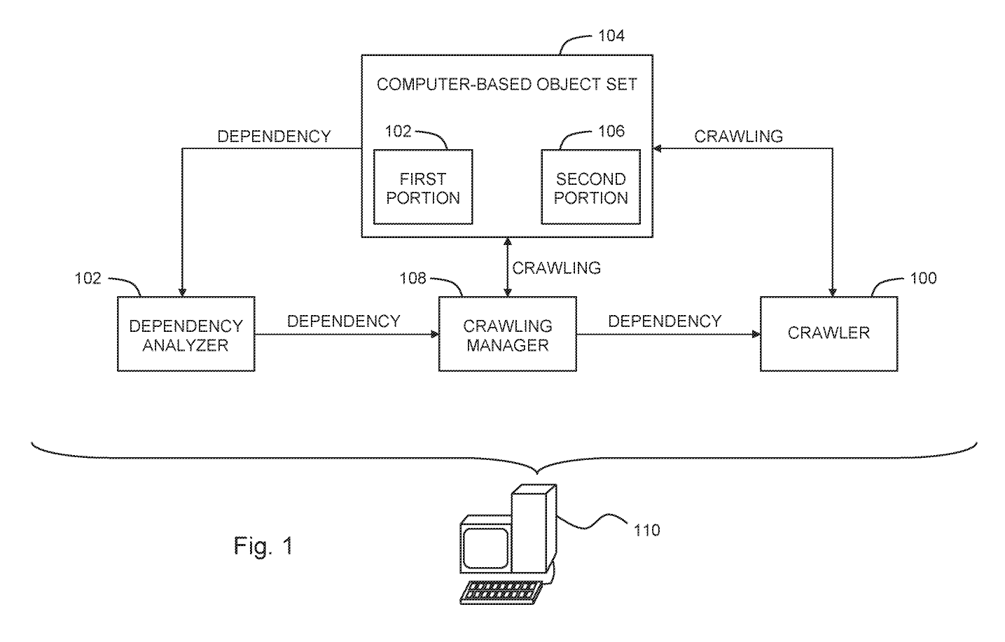

Reference is now made to FIG. 1 which is a simplified conceptual illustration of a system for crawling computer-based objects, constructed and operative in accordance with an embodiment of the invention. In the system of FIG. 1, a dependency analyzer 100 is configured to identify a dependency between a first portion 102 of a computer-based object set 104 and a second portion 106 of object set 104, where second portion 106 is data-dependent on first portion 102. Object set 104 includes one or more computer-based objects of any type that is suitable for crawling using conventional crawling techniques, including computer-based documents configured for use with mainframe and desktop computers and mobile computing devices, such as “web” applications including Hypertext Markup Language (HTML)-encoded web pages that may be hosted by a computer server and accessed by one or more client computers via a computer network, such as the Internet, and interfaces of other types of computer software applications. Such web applications may include Rich Internet Applications (RIAs) that include client-side scripting and dynamic content. First portion 102 and second portion 106 may be different portions of the same or different objects in object set 104. For example, first portion 102 and second portion 106 may be separate JavaScript™ methods within the same HTML-encoded web page that include executable computer software instructions. Dependency analyzer 100 is preferably configured to perform static analysis of the objects in object set 104, such as by performing data dependency analysis to identify any data dependencies between first portion 102 and second portion 106. For example, dependency analyzer 100 may be configured to identify an operand of an operation that second portion 106 is configured to perform, and determine that a value of the operand is dependent upon an operation that first portion 102 is configured to perform.

A crawling manager 108 is configured to effect the crawling of first portion 102, and thereafter the crawling of second portion 106, in response to dependency analyzer 100 identifying that second portion 106 is data-dependent on first portion 102. Crawling manager 108 may accomplish this by itself performing the crawling of first portion 102, followed by the crawling of second portion 106, in accordance with conventional techniques, such as by causing their computer software instructions to be executed. Additionally or alternatively, crawling manager 108 may effect the crawling by notifying a separate crawler 110 that first portion 102 is to be crawled before second portion 106 is crawled, whereupon crawler 110 performs the crawling of first portion 102 followed by the crawling of second portion 106 in accordance with conventional techniques.

Any of the elements shown in FIG. 1 are preferably implemented by a computer, such by a computer 110, by implementing any of the elements in computer hardware and/or in computer software embodied in a non-transitory, computer-readable storage medium in accordance with conventional techniques.

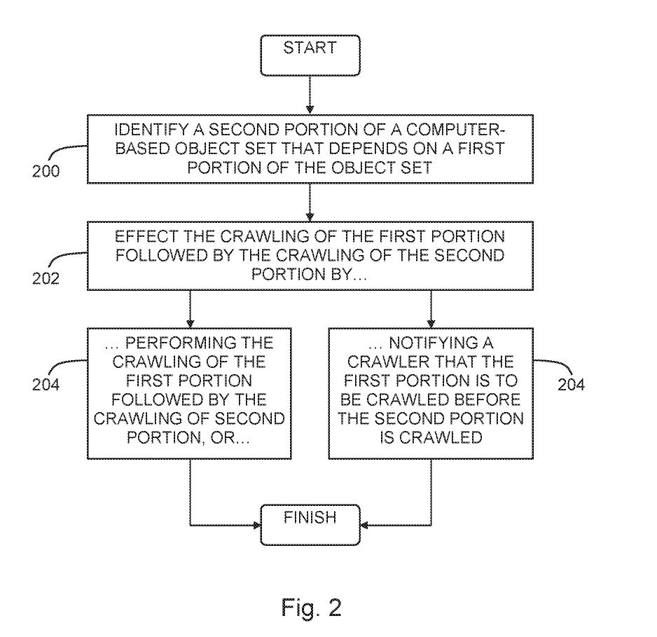

Reference is now made to FIG. 2, which is a simplified flowchart illustration of an exemplary method of operation of the system of FIG. 1, operative in accordance with an embodiment of the invention. In the method of FIG. 2 a dependency between first and second portions of a computer-based object set is identified (step 200), where the second portion is data-dependent on the first portion. The crawling of the first portion, followed by the crawling of second portion, is effected (step 202), either by performing the crawling of the first portion followed by the crawling of second portion (step 204), or by notifying a crawler that the first portion is to be crawled before the second portion is crawled (step 206).

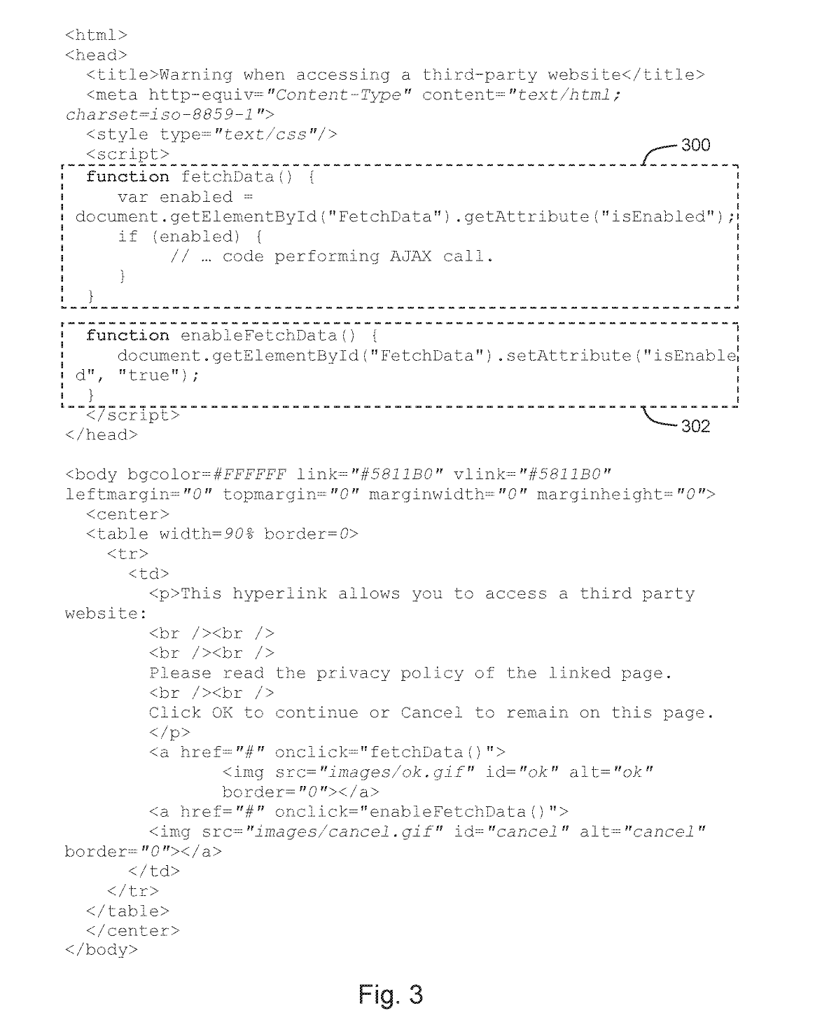

The system of FIG. 1 and method of FIG. 2 may be illustrated in the context of the example shown in FIG. 3, in which there are two JavaScript™ methods, fetchData 300 and enableFetchData 302, which communicate via attribute isEnabled of element FetchData. If this attribute is set to true, then an AJAX call is performed by fetchData to retrieve data from the server side of the web application. By applying the system of FIG. 1 and method of FIG. 2, a dependency between fetchData 300 and enableFetchData 302 is detected using static analysis, revealing that fetchData 300 reads the FetchData/isEnabled attribute, and enableFetchData 302 writes this attribute. Based on this read-after-write dependency enableFetchData 302 would be crawled first, followed by crawling fetchData 302.

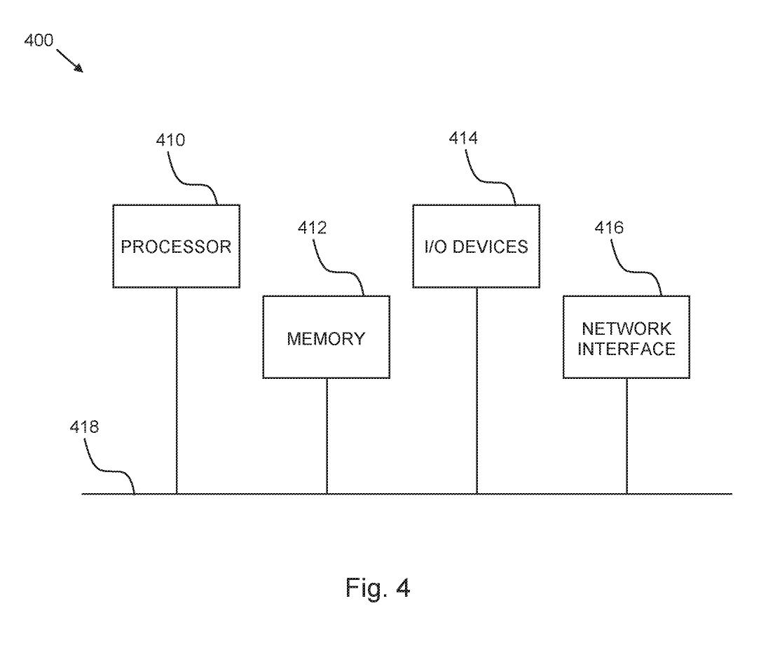

Referring now to FIG. 4, block diagram 400 illustrates an exemplary hardware implementation of a computing system in accordance with which one or more components/methodologies of the invention (e.g., components/methodologies described in the context of FIGS. 1-2) may be implemented, according to an embodiment of the invention.

As shown, the techniques for controlling access to at least one resource may be implemented in accordance with a processor 410, a memory 412, I/O devices 414, and a network interface 416, coupled via a computer bus 418 or alternate connection arrangement.

It is to be appreciated that the term “processor” as used herein is intended to include any processing device, such as, for example, one that includes a CPU (central processing unit) and/or other processing circuitry. It is also to be understood that the term “processor” may refer to more than one processing device and that various elements associated with a processing device may be shared by other processing devices.

The term “memory” as used herein is intended to include memory associated with a processor or CPU, such as, for example, RAM, ROM, a fixed memory device (e.g., hard drive), a removable memory device (e.g., diskette), flash memory, etc. Such memory may be considered a computer readable storage medium.

In addition, the phrase “input/output devices” or “I/O devices” as used herein is intended to include, for example, one or more input devices (e.g., keyboard, mouse, scanner, etc.) for entering data to the processing unit, and/or one or more output devices (e.g., speaker, display, printer, etc.) for presenting results associated with the processing unit.

The flowchart and block diagrams in the Figures illustrate the architecture, functionality, and operation of possible implementations of systems, methods and computer program products according to various embodiments of the invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It will be appreciated that any of the elements described hereinabove may be implemented as a computer program product embodied in a computer-readable medium, such as in the form of computer program instructions stored on magnetic or optical storage media or embedded within computer hardware, and may be executed by or otherwise accessible to a computer.

While the methods and apparatus herein may or may not have been described with reference to specific computer hardware or software, it is appreciated that the methods and apparatus described herein may be readily implemented in computer hardware or software using conventional techniques.

While the invention has been described with reference to one or more specific embodiments, the description is intended to be illustrative of the invention as a whole and is not to be construed as limiting the invention to the embodiments shown. It is appreciated that various modifications may occur to those skilled in the art that, while not specifically shown herein, are nevertheless within the true spirit and scope of the invention.

What is claimed is:

1. A system for crawling computer-based objects, the system comprising:
a dependency analyzer configured to identify a dependency between a first portion of a computer-based object set and a second portion of the computer-based object set, wherein the object set comprises a plurality of objects, wherein the first portion and second portion are separate JavaScript methods within an Hypertext Markup Language (HTML) encoded web page and the first and second portion includes executable computer software instructions, wherein the second portion is data-dependent on the first portion and identifying the dependency is based on performing a static analysis and a dependency analysis of the plurality of objects in the computer-based object set, wherein the dependency analyzer is configured to identify an operand of an operation that the second portion is configured to perform, and determine that a value of the operand is dependent upon an operation that the first portion is configured to perform;
a crawling manager configured to, responsive to identifying the dependency, effect a crawling of the first portion and a crawling of the second portion, wherein the effecting comprises causes the computer software instruction to be executed, wherein the crawling manager effects the crawling by notifying a separate crawler that the first portion is to be crawled before the second portion is crawled, wherein the separate crawler performs the crawling of the first portion followed by the crawling of the second portion; and
wherein the dependency analyzer and the crawling manager are implemented in a computer hardware.
